(19) United States
(12) Patent Application Publication
(10) Pub. No.: US 2009/0087557 A1
(43) Pub. Date: Apr. 2, 2009

(54) METHOD OF MANUFACTURING A MAGNETITE-COATED IRON POWDER

(75) Inventors: Kenji KAWANO, Takasaki-shi (JP); Toshinobu YOGO, Takasaki-shi (JP)

Correspondence Address: K.A. PATENTS, 7613 East 90th Street, KANSASS CITY, MO, 64138, US

(73) Assignee: TAIYO YUDEN CO., LTD., Tokyo (JP)

(21) Appl. No.: 12/240,977

(22) Filed: Sep. 29, 2008

(30) Foreign Application Priority Data
Oct. 1, 2007 (JP) 2007-257245

(51) Int. Cl. B05D 1/00

(52) U.S. Cl. 427/216

(57) ABSTRACT

A method of manufacturing a magnetite-coated iron powder includes putting an iron powder into a reaction liquid containing iron pentacarbonyl and heating the same in an oxidizing atmosphere, or includes heating a reaction liquid containing iron pentacarbonyl in a reducing atmosphere thereby precipitating iron particles and heating the reaction liquid in which iron particles are precipitated in an oxidizing atmosphere and coating magnetite to the precipitate iron particles.

### BACKGROUND OF THE INVENTION

1. Field of the Invention

The present invention provides a method of coating magnetite (Fe₃O₄) on the surface of an iron powder which can control the film thickness of magnetite easily.

2. Description of the Related Art

In recent years, the operation frequency for circuits forming electronic instruments has been increased to a high frequency region as reaching a GHz level. Therefore, it has been demanded also for electronic parts forming the circuits that they operate normally in a high frequency region. Also for a wire wound type inductor having a magnetic substance core applied with windings, it has been required that the inductor operates normally in the high frequency region. It is necessary that the magnetic substance core used for the wire wound type inductor conforming to high frequency has high saturation magnetization, high magnetic permeability, and high electric resistivity. As the material for forming the magnetic substance core having such electric characteristics, an iron powder coated at the surface with magnetite (Fe₃O₄) is used.

An iron powder coated with magnetite is formed by coating an iron powder particle having high saturation magnetization and high magnetic permeability but low electric resistivity with magnetite having high electric resistivity. As method of forming an iron powder coated with magnetite, there have been proposed a method of heat treating an iron powder thereby oxidizing the surface and a method of bonding an iron powder and an oxide powder by mixing them in a vibrating mill as disclosed in Japanese Unexamined Patent Publication No. 2002-256304.

### SUMMARY OF THE INVENTION

For obtaining a magnetic substance core having high saturation magnetization, high magnetic permeability, and high electric resistivity together, it is necessary to control the film thickness of magnetite coated on the iron powder. That is, in a case where the film thickness of magnetite is larger, while the electric resistivity increases, saturation magnetization and magnetic permeability decrease. On the other hand, in a case where the film thickness of magnetite is smaller, while saturation magnetization and magnetic permeability increase, the electric resistivity decreases. Accordingly, it is necessary to control the film thickness of magnetite so as to make saturation magnetization, and magnetic permeability, and electric resistivity compatible to each other.

However, in the method of heat treating the iron powder thereby oxidizing the surface, since formation of an oxide film proceeds no more after the oxide film is formed over the entire surface, it is difficult to control the thickness of the oxide film. Further, in the method disclosed in JP-A NO. 2002-256304, since the film is formed by a mechanical treatment, the film thickness tends to be varied and control for the thickness of the magnetite is difficult.

An embodiment of the present invention is intended to solve at least one of the foregoing problems and provide a method capable of obtaining an iron powder which is coated with magnetite with easy control for the film thickness and at a uniform thickness.

The disclosed embodiments of the present invention propose, in a first aspect, a method of manufacturing a magnetite-coated iron powder of coating magnetite on the surface of an iron powder including a step of putting an iron powder in a reaction liquid containing iron pentacarbonyl and heating the same in an oxidizing atmosphere.

When iron pentacarbonyl is heated in the oxidizing atmosphere, a carbonyl ligand is dissociated by pyrolysis and iron as the central metal is oxidized by the oxidizing atmosphere into magnetite and precipitated on the surface of the iron powder in the reaction liquid. In this way, magnetite is precipitated successively to form a film. According to the first aspect of the disclosed embodiments of the invention, the magnetite can be formed to a uniform film thickness and the film thickness can be controlled easily.

Further, the disclosed embodiments of the present invention propose, in a second aspect, a method of manufacturing a magnetite-coated iron powder including a step of heating a reaction liquid containing iron pentacarbonyl in a reducing atmosphere thereby precipitating iron particles, and a step of heating the reaction liquid in which the iron particles are precipitated in an oxidizing atmosphere thereby coating magnetite on the precipitated iron particles.

The second aspect is identical with the first aspect in that magnetite is formed at a uniform film thickness and the film thickness can be controlled easily but is different from the first aspect in that the iron powder to be coated is formed by pyrolysis of iron pentacarbonyl. Iron pentacarbonyl is pyrolyzed in a reducing atmosphere to precipitate iron particles and then the reaction liquid containing the precipitated iron particles is heated in an oxidizing atmosphere to precipitate magnetite and coat the same on the surface of the previously precipitated iron particles.

According to the second aspect of the disclosed embodiments of the invention, since magnetite is coated in a state where the iron particles to be coated is scarcely oxidized, purity of the iron particle is enhanced. Accordingly, the magnetite-coated iron powder by the second aspect of the disclosed embodiments of the invention can provide higher permeability and higher saturation magnetization compared with a case of putting the previously prepared iron powder into the reaction liquid. Further, the second aspect of the disclosed embodiments of the invention can form the iron particle as a core and provide coating of magnetite to the iron powder continuously.

According to at least one embodiments of the invention, an iron powder coated with magnetite with easy control for the film thickness and at a uniform thickness can be obtained.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### DESCRIPTION OF THE ACCOMPANYING DRAWINGS

These and other features of this invention will now be described with reference to the drawing of a preferred embodiment which is intended to illustrate and not to limit the invention. The drawing is oversimplified for illustrative purposes and is not to scale.

FIG. 1 is a conceptional view showing an apparatus used for the manufacturing method of an embodiment of the invention.

### PREFERRED EMBODIMENTS OF THE INVENTION

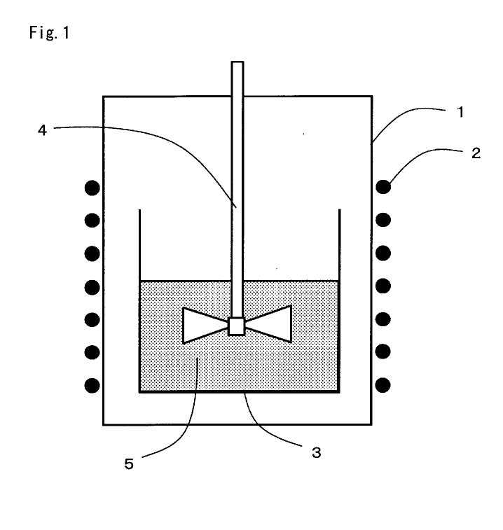

A first embodiment according to the manufacturing method of the invention is to be described. This embodiment is not intended to limit the present invention. FIG. 1 is a conceptional view for an apparatus used in this embodiment of the invention. As shown in FIG. 1, a closed vessel 1 having a heating means 2 and a stirring means 4 is provided. The closed vessel 1 has a solution tank 3 for containing a reaction liquid 5.

At first, the reaction liquid 5 is contained in the solution tank 3. The reaction liquid 5 is a solution containing iron pentacarbonyl. Since iron pentacarbonyl is liquid at a normal temperature, it may be used as it is for the reaction liquid, or it may be mixed with an organic solvent so as to moderate the reaction. The organic solvent to be used herein includes alcohols such as ethanol and 2-methoxy ethanol, and benzene and decalin, and any other suitable organic solvents. The mixing ratio of iron pentacarbonyl and the organic solvent is preferably 1:80 to 1:200 by volume ratio. Since the amount of precipitated magnetite can be controlled by controlling the mixing ratio of iron pentacarbonyl and the organic solvent, the thickness of the magnetite film can be controlled by controlling the mixing ratio of iron pentacarbonyl and the organic solvent.

Successively, an iron powder is placed in the reaction liquid 5. For uniform coating, it is preferred that the iron powder is charged while stirring the reaction liquid 5 by the stirring means 4. The ratio of the iron powder and the reaction liquid 5 is preferably from 1:20 to 1:50 by volume ratio. Successively, after filling an oxidizing atmosphere, the closed vessel 1 is closed tightly (i.e., gas-tightly closed). In a case of reaction in the atmosphere, the vessel is closed tightly as it is. The oxidizing atmosphere may also be an atmospheric air. A gas mixed with nitrogen to lower the oxygen concentration may also be used for moderating the reaction. Further, the stirring means 4 includes, for example, a rotary blade as shown in FIG. 1.

Successively, the oxidizing atmosphere inside the closed vessel 1 is heated by the heating means 2. The reaction liquid 5 is heated by the heated oxidizing atmosphere to pyrolyze iron pentacarbonyl. Since the decomposition temperature of iron pentacarbonyl in a closed system is 150° C., it is heated to a temperature of 150° C. or higher. Iron molecules precipitated by pyrolysis of iron pentacarbonyl are oxidized by the oxidizing atmosphere into magnetite. The magnetite is deposited to the surface of the iron powder to form a magnetite film. The thickness of the magnetite film can be controlled depending on the heating temperature and the reaction time. When the magnetite film reaches a desired thickness, the reaction liquid 5 is filtrated to recover an iron powder, which is washed and dried. Thus, the magnetite-coated iron powder is obtained.

Next, a second embodiment according to the manufacturing method of the invention is to be described. This embodiment is not intended to limit the present invention. The apparatus used herein is as per the conceptional view shown in FIG. 1, which is identical with that for the first embodiment. The second embodiment is different in that the iron powder to be coated is formed by pyrolysis of iron pentacarbonyl. The conditions in the first embodiment can apply to the second embodiment unless mentioned otherwise.

At first, a reaction liquid 5 is contained in the solution tank 3. The reaction liquid 5 is a solution containing iron pentacarbonyl identical with that for the first embodiment, which may be used as it is as the reaction liquid, or may be mixed with an organic solvent for moderating the reaction. Further, the amount of the iron powder to be precipitated and the particle diameter can be controlled by controlling the mixing ratio of iron pentacarbonyl and the organic solvent. Successively, after filling a reducing atmosphere, the closed vessel 1 is closed tightly. As the reducing atmosphere, a hydrogen gas, a nitrogen-hydrogen mixed gas, other hydrogen-containing gas, etc. may be used.

Successively, the reducing atmosphere inside the closed vessel 1 is heated by the heating means 2. The reaction liquid 5 is heated by the heated reducing atmosphere and iron pentacarbonyl is pyrolyzed while stirring the reaction liquid 5 by the stirring means 4, thereby forming iron particulates. Since the iron molecules precipitated by pyrolysis of iron pentacarbonyl are in the reducing atmosphere, they are not oxidized but bonded with other iron molecules to form iron particles. The thus obtained iron particle powder is at a high purity. The particle diameter of the iron powder can be controlled depending on the heating temperature and the reaction time.

When the particle diameter of the iron powder reaches a desired size, the closed vessel 1 is opened to replace the reducing atmosphere with an oxidizing atmosphere. The oxidizing atmosphere may be identical with that for the first embodiment. Since the concentration of iron pentacarbonyl in the reaction liquid 5 is lowered by the reaction of forming the iron particles, iron pentacarbonyl in an amount to form the magnetite film may be added to the reaction liquid 5 (e.g., to compensate for the diminished amount of iron pentacarbonyl) upon or at replacement of the atmosphere. After completion for the replacement of the atmosphere, the closed vessel 1 is closed tightly.

Successively, the oxidizing atmosphere inside the closed vessel 1 is heated by the heating means 2. The reaction liquid 5 is heated by the heated oxidizing atmosphere and iron pentacarbonyl is pyrolyzed while stirring the reaction liquid 5 by the stirring means 4. The iron molecules precipitated by decomposition of iron pentacarbonyl are oxidized by the oxidizing atmosphere into magnetite in the same manner as in the first embodiment. The magnetite is deposited to the surface of the iron powder to form a magnetite film. When the magnetite film reaches a desired thickness, the reaction liquid 5 is filtered to recover an iron powder, which is cleaned and dried.

Since the magnetite-coated iron powder obtained as described above has a relatively high purity for the iron powder, it has higher magnetic permeability and higher saturation magnetization compared with those obtained by coating magnetite to a previously prepared iron powder.

In the present disclosure where conditions and/or structures are not specified, the skilled artisan in the art can readily provide such conditions and/or structures, in view of the present disclosure, as a matter of routine experimentation. Also, in the present disclosure, the numerical numbers applied in specific embodiments can be modified by a range of at least ±50% in other embodiments, and the ranges applied in embodiments may include or exclude the endpoints.

### EXAMPLE

### Example 1

500 mg of iron pentacarbonyl and 5 ml of decalin were mixed to prepare a reaction liquid. Then, a closed vessel of 4.0 cm inner diameter and 19 cm depth having a rotary blade for stirring was provided, and a glass vessel of 3.5 cm inner diameter and 8.0 cm height was placed as a solution tank in the closed vessel. The reaction liquid described above was contained in the solution tank. Then, 320 mg of an iron powder with an average value of the particle diameter of 3 μm was charged in the solution tank while stirring the reaction liquid by the rotary blade. Then, the cover for the closed vessel was closed to seal the vessel.

Then, the closed vessel was heated by a heater wound around the periphery thereof to elevate the temperature in the closed vessel to 350° C. Reaction was carried out at 350° C. for 5 hours and, when the temperature was lowered to room temperature, the reaction liquid was taken out. The taken out reaction liquid was filtered through filter paper (No. 2) and the obtained iron powder was washed with acetone and dried at 150° C. for 1 hr.

In addition to the sample (Sample 1) as described above, a sample heated at a reaction temperature of 250° C. (Sample 2) and a sample heated at a reaction temperature of 300° C. (Sample 3) were provided in the same manner. The samples were observed by SEM (Scanning Electron Microscope) and XRD (X-Ray Analyzer) to confirm the formation of the magnetite film and measure the film thickness. Further, the samples were filled each in a predetermined amount in a sample case made of an acrylic resin and the saturation magnetization was evaluated at room temperature by a sample vibration type magnetometer.

The thickness for the magnetite film was 220 nm for Sample 1, 80 nm for Sample 2 and 150 nm for Sample 3. The electric resistivity was 10.52 Ωm for Sample 1, 0.32 Ωm for Sample 2, and 3.58 Ωm for Sample 3. Further, saturation magnetization was 173 emu/g for Sample 1, 216 emu/g for Sample 2, and 209 emu/g for Sample 3. As described above, it has been found that the film thickness can be controlled easily and the electric resistivity and the saturation magnetization can be controlled by controlling the reaction temperature according to at least this embodiment of the invention.

### Example 2

500 mg of iron pentacarbonyl and 5 ml of decalin were mixed to prepare a reaction liquid. Then, a closed vessel of 4.0 cm inner diameter and 19 cm depth having a rotary blade for stirring was provided, and a glass vessel of 3.5 cm inner diameter and 8.0 cm height was placed as a solution tank in the closed vessel. The reaction liquid described above was contained in the solution tank. Then, a nitrogen-hydrogen mixed gas comprising 97% nitrogen and 3% hydrogen was filled inside the closed vessel and the cover was closed to seal the vessel.

Then, the closed vessel was heated by a heater wound around the periphery thereof to elevate the temperature in the closed vessel to 250° C. Reaction was carried out at 250° C. for 5 hours while stirring the reaction liquid by the rotary blade to form 93 mg of an iron powder with an average value of 3 μm for the particle diameter.

Then, the cover for the closed vessel was opened to replace the nitrogen-hydrogen mixed gas with an atmospheric air. Then, 150 mg of iron pentacarbonyl was added to the reaction liquid in the solution tank. Then, the cover for the closed vessel was closed to seal the vessel.

Then, the closed vessel was heated by a heater wound around the periphery thereof to elevate the temperature in the closed vessel to 380° C. Reaction was carried out at 380° C. for 5 hours and, when the temperature was lowered subsequently to room temperature, the reaction liquid was taken out. The taken out reaction liquid was filtered through filter paper (No. 2) and the obtained iron powder was washed with acetone and dried at 150° C. for 1 hr.

In addition to the sample (Sample 4), a sample with addition of 100 mg of iron pentacarbonyl (Sample 5) and a sample with addition of 200 mg of iron pentacarbonyl (Sample 6) were provided. The samples were observed by SEM (Scanning Electron Microscope) and XRD (X-Ray Analyzer) to confirm the formation of the magnetite film and measure the film thickness. Further, for the samples, electric resistivity and saturation magnetization were measured in the same manner as in Example 1.

The thickness for the magnetite film was 200 nm for Sample 4, 120 nm for Sample 5 and 280 nm for Sample 6. The electric resistivity was 9.72 Ωm for Sample 4, 3.02 Ωm for Sample 5 and 12.5 Ωm for Sample 6. Further, saturation magnetization was 190 emu/g for Sample 4, 200 emu/g for Sample 5, and 162 emu/g for Sample 6. As described above, it was found that the film thickness could be controlled easily and electric resistivity and saturation magnetization can be controlled by controlling the concentration of iron pentacarbonyl according to at least this embodiment of the invention. When the Sample 1 and Sample 4 were compared, it was found that the Sample 4 has higher saturation magnetization.

In embodiments, the present invention can be used for the manufacture of a magnetic substance material used for a magnetic substance core of a wire wound inductor conforming to high frequency use and it can be used also for a rust-prevention treatment of an iron powder.

The present application claims priority to Japanese Patent Application No. 2007-257245, filed Oct. 1, 2007, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A method of manufacturing a magnetite-coated iron powder, comprising:
providing an iron powder in a reaction liquid containing iron pentacarbonyl; and
heating the reaction liquid with the iron powder in an oxidizing atmosphere at a temperature higher than the decomposition temperature of iron pentacarbonyl, thereby forming magnetite on a surface of the iron powder.

2. The method according to claim 1, wherein the step of heating is conducted in a closed vessel.

3. The method according to claim 1, wherein the reaction liquid contains an organic solvent.

4. The method according to claim 1, wherein the volume ratio of the iron powder to the reaction liquid is 1:20 to 1:50.

5. The method according to claim 1, further comprising increasing a thickness of the magnetite as a function of the temperature of the oxidizing atmosphere.

6. The method according to claim 3, further comprising increasing a thickness of the magnetite as a function of the concentration of the iron pentacarbonyl in the reaction liquid.

7. The method according to claim 1, wherein the step of providing the iron powder comprises adding the iron powder in the reaction liquid while stirring the reaction liquid.

8. The method according to claim 1, wherein the step of providing the iron powder comprises heating a reaction liquid containing iron pentacarbonyl in a reducing atmosphere at a temperature higher than the decomposition temperature of iron pentacarbonyl, thereby precipitating iron particles as the iron powder in the reaction liquid.

9. The method according to claim 8, wherein after the step of providing the iron powder but before the step of heating in the oxidizing atmosphere, iron pentacarbonyl is added to the reaction liquid.

10. The method according to claim 8, wherein the step of providing the iron powder and the step of heating in the oxidizing atmosphere are conducted in a same closed vessel, and after the step of providing the iron powder, the closed vessel is cooled, and the reducing atmosphere is replaced with the oxidizing atmosphere.

11. The method according to claim 1, further comprising recovering the magnetite-coated iron powder from the reaction liquid, and drying obtaining the magnetite-coated iron powder.

12. A method of manufacturing a magnetite-coated iron powder, comprising:
heating a reaction liquid containing iron pentacarbonyl in a reducing atmosphere, thereby precipitating iron particles, and
heating the reaction solution in which the iron particles are precipitated in an oxidizing atmosphere, thereby forming a magnetite coating on the precipitated iron particles.

13. The method according to claim 12, wherein the step of heating in the reducing atmosphere and the step of heating in the oxidizing atmosphere are conducted in a same closed vessel.

14. The method according to claim 12, wherein after the step of heating in the reducing atmosphere but before the step of heating in the oxidizing atmosphere, iron pentacarbonyl is added to the reaction liquid.

15. The method according to claim 13, wherein after the step of heating in the reducing atmosphere, the closed vessel is cooled, and the reducing atmosphere is replaced with the oxidizing atmosphere.
